(19) United States
(12) Patent Application Publication
(10) Pub. No.: US 2008/0201744 A1
(43) Pub. Date: Aug. 21, 2008

(54) Method and System For Managing Recorded Content Channels

(75) Inventor: Rohan Cajetan Lobo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,181

(22) PCT Filed: Jul. 10, 2006
(86) PCT No.: PCT/IB06/52331

§ 371 Date: Jan. 9, 2008

Related U.S. Application Data
(60) Provisional application No. 60/698,443, filed on Jul. 12, 2005.

(51) Int. Cl. H04N 5/445; G06F 3/00

(52) U.S. Cl. 725/46; 348/563

(57) ABSTRACT

Disclosed is a system and method for managing program contents according to the preferences of the user and then presented in an assigned channel specified by the user. The system executes the following steps: receiving at least one program content; assigning the program content to an unused channel or one of the pre-assigned channels containing similar programs in response to a user input; and displaying the program content using the unused channel selected by the user while viewing other television programs being watched.

The present invention relates to a system for managing video contents and, in particular, to a method and system for managing recorded contents using one or more content channels created from unused/untuned channels.

The modern world with huge amounts of multimedia content and varied delivery options gives us a tremendous variety and range of options and choices. Cable and satellite television delivers hundreds of different television channels each carrying a different program. Nowadays, it is a common practice to record audio or video content on a TV, PC or other portable devices. As the number of programs has increased, it has become challenging for viewers to sort programs of interest. Therefore, there is a need to provide the viewer with easy management and access to his or her recorded content.

The present invention provides a means so that the recorded materials of interest are presented to the viewer so that viewers can easily manage the content. An unused channel is designated to access the viewer's pre-recorded contents or a group of related contents such that the viewer is able to access the program of interest while watching a plurality of TV/radio/other programs.

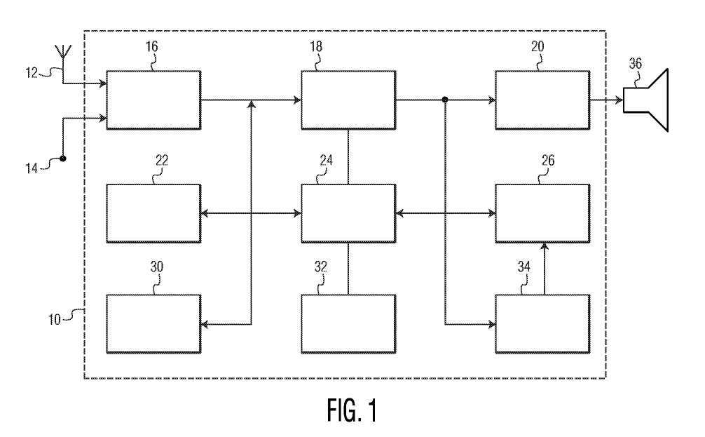

FIG. 1 is a block diagram of a video-processing system in which the invention may be implemented.

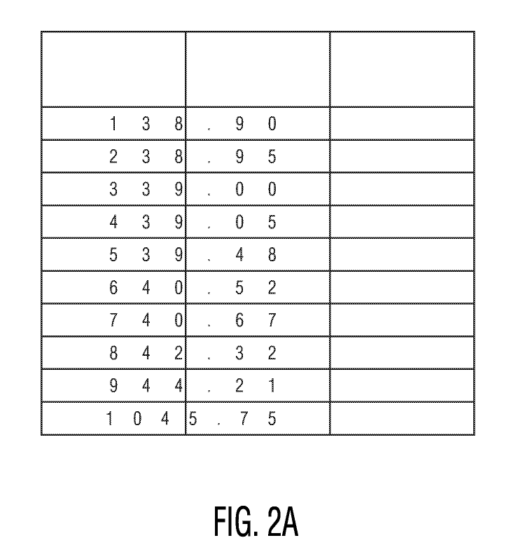

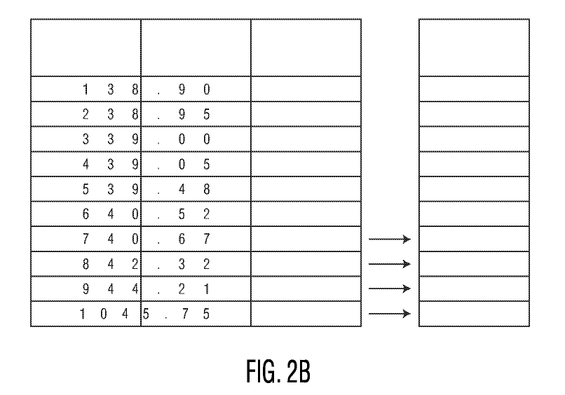

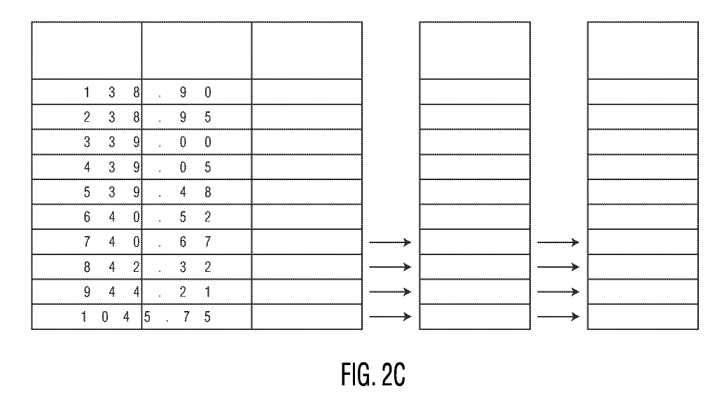

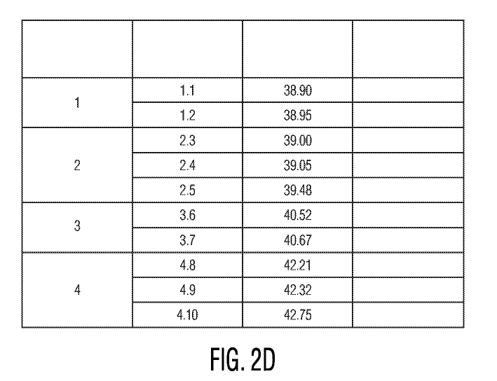

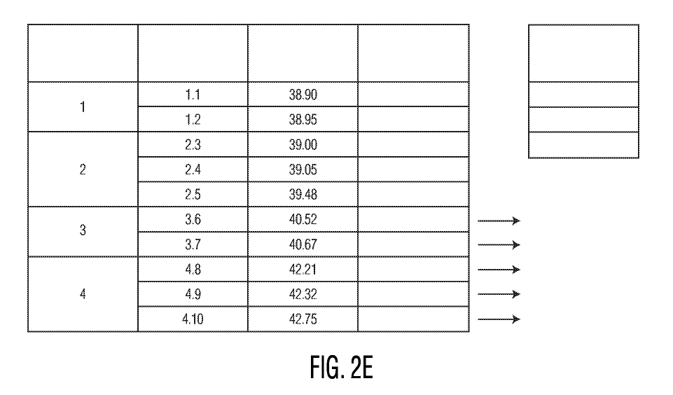

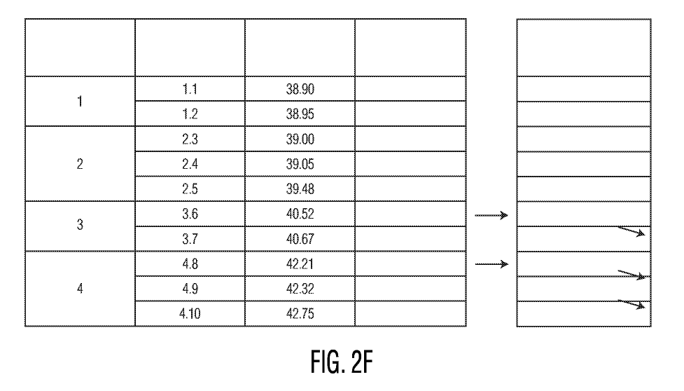

FIG. 2a-FIG. 2f are examples of channel-map tables for creating a channel according to the present invention.

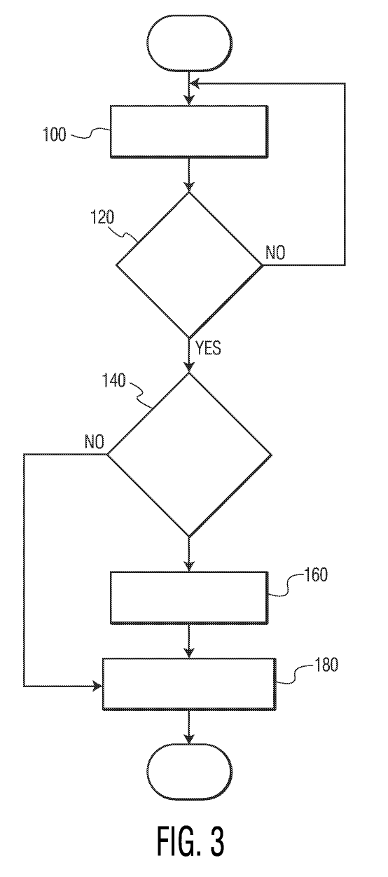

FIG. 3 is a flow diagram for creating a channel in accordance with an illustrative embodiment of the invention that may be implemented in the video -processing system of FIG. 1.

It is to be understood by persons of ordinary skill in the art that the following descriptions are provided for purposes of illustration and not for limitation. An artisan understands that there are many variations that lie within the spirit of the invention and the scope of the appended claims. For the purposes of clarity and simplicity, unnecessary detail of known functions and operations may be omitted from the current description so as not to obscure the present invention.

Referring to FIG. 1, an embodiment of the present invention is a system 10 for providing easy access to one or more types of pre-recorded contents. The system 10 includes a tuner 16, a codec 18, an audio processor 20, an unused module 22, a controller 24, a display 26, a memory 30, a user interface 32, a video processor 34, and a speaker 36.

As it will be described in greater detail below, the system 10 may represent or incorporate a television, a set-top box, a mobile phone, a desktop, laptop or palmtop computer, a personal digital assistant (PDA), a video-storage device such as a videocassette recorder (VCR), a digital video recorder (DVR), an optical disk, magnetic disk or solid state-based recorder such as a TiVO or Replay TV device, etc., as well as portions or combinations of these and other devices. The system 10 is configured to receive audio/video programming from the conventional television (TV) broadcast 12 and a cable 14, respectively. The broadcaster 12 may represent any service provider such as a terrestrial broadcast system, a cable network, a satellite network or an Internet network that broadcasts content. The audio/video programming can be delivered in analog, digital or digitally compressed formats via any transmission means, including satellite, cable, wire, television broadcast, or it can be sent via the Web. The Internet connection can be via a high-speed line, RF, conventional modem or by way of a two-way cable carrying the video programming.

The tuner 16 may be a standard analog RF receiving device for receiving the RF signals. Alternatively, the tuner 16 may be a digital tuner. Digital broadcast streams, modulated upon RF signals, may be received either by the antenna 12 or from the cable 14. The codec 18 decodes incoming video to be displayed in the display 26 and for coding video to be stored in the memory 30. Other audio/video programs can be stored in a memory 16 for later replay in the display unit 26. Alternatively, the memory 30 may represent a disk capable of storing audio/video programs for later viewing by the user. Hence, the memory 30 may be embodied by a hard drive, a recordable DVD or other similar mass storage device. The codec 18 may be embodied by a MPEG-1, MPEG-2, MPEG-4 or other known standard. The audio processor 20 decodes the video stream from the codec 18, and the decoded audio data is transmitted to the speaker 36. As it can be seen later, the unused channel module 22 serves to designate one or more unused channels for viewing an already recorded program. The controller 24 comprises one or more microprocessors capable of executing program instructions stored in a read-only memory (not shown) and oversees the overall operation of the system 10. The user interface 32 will enable a user to command and operate the system 10 and may represent a remote control, a keyboard or other similar device. The video processor 8 decodes the video stream received from the codec 18 or from the controller 24, and decoded video data is then transmitted to the display 26.

The functions of the various elements shown in the FIG. 1, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementor as more specifically understood from the context.

During a viewing mode, the present invention provides an optimum use of unused channels to enable the viewer to access a pre-recorded content or a group of related content. For example, while setting up a program for recording, viewing, or taking an already-recorded program, a user is provided with an option to designate an unused channel to be used for direct access to one or more types of program contents. Further, a user can also designate a channel to a group of related recorded programs for viewing. There after, as the viewer is channel surfing a number of channels, the viewer is able to access the program of interest, via designated unused channel playing the video and audio content assigned previously. Note that still images, such as slideshows, may be assigned to an unused channel for later viewing. This concept can be illustrated with a couple of examples as shown in FIGS. 2a through 2f, hereinafter.

FIG. 2a shows a channel map for an analog (audio or video) tuner. As shown, channels 1 to 6 are turned to a frequency corresponding to various TV networks, but channels 7 to 10 are unused or untuned.

Referring to FIG. 2b, if a user exercises an option to set a particular movie, “Shrek,” for recording, or if the movie “Shrek” has been already recorded or is available on the hard disk such as a DVD, the user is able to assign this movie to Channel 7. Similarly, other movies may be assigned to other unused channels, as shown in FIG. 2b. Thereafter, if the user presses channel 7 during a viewing mode, the movie “Shrek” can begin to play as if the tuner 16 were transmitting the movie “Shrek” from a broadcaster. As such, if the movie is recording or being played, the user can use the channel up/channel down keys on a remote control to browse through one or more movies of his or her preference.

Referring to FIG. 2c, in an alternate embodiment, the user may set a used channel to be used as direct access to a specific type of content. For example, the user may specify the unused channel 7 to refer to all movies belonging to the “Animation” type movies, or channel 8 to group all crime-related programs. During a viewing mode, one or more “Animation” movies would be played in sequence in channel 7, thus providing the user with easy access to all programs related to the animation-type movie. The user may use the FastForward/Reverse keys to browse the movies, or use chapter buttons or other equivalent keys on a remote control to browse the series of different movies belonging to one particular theme. This method can also be used to group together movies based on a keyword, such as the actress name “Julia Roberts,” to channel 9 for subsequent replay.

In an alternate embodiment, the system 10 may be equipped with a digital tuner having multicasting capability. In multicasting, multiple signals are broadcast over the same channel by effectively splitting the channel into sub-channels.

FIG. 2d shows a channel map for a digital (audio or video) tuner. Multicasting can be particularly useful when grouping related programs. As shown, channel 1 contains two multicasted channels, 1.1 and 1.2. Channel 2 contains three multicasted channels, 2.3, 2.4 and 2.5, etc. Channels 1 and 2, including their multicasted channels, are tuned to major broadcaster's channels. However, channels 3 and 4, including their multicasted channels, are not tuned to any channel and are thus unused.

Referring to FIG. 2e, if a user sets the movie “Shrek” for recording or replay from a pre-recorded medium, one of the unused channels, 3.6, may be as signed to play this movie. Thus, if the user presses channel 3.6, the movie “Shreak” can begin to play as if the tuner were transmitting the movie “Shreak.” During the viewing mode, the user can use the channel up/channel down keys in a remote to surf the multicasted channels.

Referring to FIG. 2f, the user may set a used channel to be used as direct access to provide a group of related programs. As shown in FIG. 2f, the unused channel 3 may be designated to refer to all movies belonging under the category of “Animation.” All these movies would be then assigned to one of the multicasted unused channels in the order 3.6 and 3.7, etc. Thereafter, if the user changes to channel 3, the first recorded movie in its multicasted channel starts to play back. The user may use the FastForward/Reverse keys or other equivalent keys in a remote control to move through the movie. This method can also be used to group together movies based on a keyword, such as the actress name “Julia Roberts,” as shown in FIG. 2f. All the movies based on the actress “Julia Roberts” are recorded in the multicasted unused channels 4.8 4.9, etc.

FIG. 3 shows a flow diagram of managing information about the television programs in accordance with an illustrative embodiment of the invent ion.

In Step 100, during either the recording mode of incoming program or the playback mode of a particular program from a DVD, the present system is initiated in response to the user input. In step 120, the user is provided with an option to designate an unused channel to be used for direct-access later viewing. If the user wishes to designate one of the unused channels, then the user has an option to assign the program in step 100 to one of the previously assigned channels in step 140. If the user chooses to elect one of the previous channels in step 140, the user can browse the pre-assigned channels in step 160 and then assign the program to the desired channel in step 180. For example, if the movie “Shrek” is being viewed in step 100, the user has an option to assign the program under the category of “Animation.”

If the program does not fall under the previously assigned channel in step 140, the program is assigned to a designated unused channel in step 180. For example, if a “Start Track” is being played in step 100, the user can set up a new title, such as “Science Fiction” to the unused channel using a user interface 32 in step 180.

While there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for processing information from a plurality of sources, said method comprising the steps of:
receiving at least one program content;
assigning at least one said program content to an unused channel, said unused channel selectable by a user; and
displaying at least one said program content via said unused channel selected by the user.

2. The method of claim 1, wherein said plurality of sources includes at least one of a television network, Internet network, wireless network, and wired network, or a combination thereof.

3. The method of claim 1, wherein said step of assigning to said unused channel is performed interactively in response to a user input.

4. The method of claim 1, wherein said unused channel is one of pre-assigned channels containing related programs.

5. The method of claim 1, wherein said at least one program content is transmitted from a memory (30).

6. The method of claim 1, wherein said at least one program content is displayed along with a plurality of programs being enjoyed by the user or stored for later playback via said unused channel selected by the user.

7. A video-processing system (10) for processing information from a plurality of sources, comprising:
means (16) for receiving at least one program content;
means (22) for assigning said at least one program content to an unused channel, said unused channel selectable by a user and
means (26) for displaying said at least one program content via said unused channel selected by the user.

8. The system of claim 7, further comprising means for storing said at least one program content for a subsequent display.

9. The system of claim 7, wherein said plurality of sources includes at least one of a television network, Internet network, wireless network, and wired network, or a combination thereof.

10. The system of claim 7, wherein said unused channel is one of pre-assigned channels containing related programs.

11. The system of claim 7, wherein said at least one program content is displayed along with a plurality of programs being enjoyed by the user or stored for later playback via said unused channel selected by the user.

12. A machine-readable medium having stored thereon data representing sequences of instructions, and the sequences of instructions which, when executed by a processor, cause the processor(24) to:
receive at least one program content;
assign said at least one program content to an unused channel in response to a user input; and
display said at least one program content via said unused channel.

13. The medium of claim 12, wherein said plurality of sources includes at least one of a television network, Internet network, wireless network, and wired network, or a combination thereof.

14. The medium of claim 1, wherein the processor is further configured to display said at least one program content along with a plurality of television programs being watched.

15. An apparatus for managing a plurality of programs, comprising:
a tuner (16) for tuning to a plurality of channels having unused channels and used channels; and
unused channel means (22) for assigning at least one program content to one of the unused channels,
wherein said apparatus is configured to control said tuner to display said at least one program content via said unused channel along with a plurality of programs being enjoyed by the user.

16. The apparatus of claim 15, wherein said plurality of programs is transmitted from at least one of a television network, Internet network, wireless network, and wired network, or a combination thereof.

17. The apparatus of claim 15, wherein said unused channel is one of pre-assigned channels containing related programs.

18. The apparatus of claim 15, wherein at least one program content is transmitted from a memory(30).
